(19) United States
(12) Patent Application Publication
(10) Pub. No.: US 2023/0411690 A1
(43) Pub. Date: Dec. 21, 2023

(54) Electrolyte and Lithium-ion Battery

(71) Applicant: EVE POWER CO., LTD., Jingmen (CN)

(72) Inventors: Chi Li, Jingmen (CN); Heng Zhang, Jingmen (CN); Fanfen Liu, Jingmen (CN); Dingding Yuan, Jingmen (CN)

(21) Appl. No.: 18/241,199

(22) Filed: Aug. 31, 2023

(30) Foreign Application Priority Data
Nov. 29, 2022 (CN) 202211518433.7

(51) Int. Cl. H01M 10/0567; H01M 10/0525; H01M 10/0568; H01M 10/0569; H01M 4/58; H01M 4/136; H01M 4/587; H01M 4/133

(52) U.S. Cl. CPC H01M 10/0567; H01M 10/0525; H01M 10/0568; H01M 10/0569; H01M 2300/004; H01M 4/136; H01M 4/587; H01M 4/133; H01M 4/5825

(57) ABSTRACT

Provided in the present application is an electrolyte and lithium-ion battery, the electrolyte including a fluorosultones compound as shown in Formula 1. The electrolyte prepared in the present application is applied to lithium iron manganese phosphate batteries, which effectively suppresses the dissolution of manganese in lithium iron manganese phosphate materials, and significantly improves the high-temperature storage performance and high-temperature cycling performance of the batteries.

### CROSS-REFERENCE TO RELATED APPLICATIONS

The present application claims priority of Chinese Patent Application No. 202211518433.7 filed on Nov. 29, 2022, the contents of which are hereby incorporated by reference in their entirety.

### FIELD

The present application relates to the field of lithium-ion battery, relates to an electrolyte, and in particular to an electrolyte and lithium-ion battery.

### BACKGROUND

At present, commercialized cathode materials of power storage battery are mainly based on ternary materials and lithium iron phosphate materials; comparing with these two cathode materials, the energy density and low-temperature performance of lithium iron manganese phosphate are better than those of lithium iron phosphate; and compared with ternary cathode, lithium iron manganese phosphate with olivine structure is more stable during charging and discharging and provides higher safety performance. In addition, considering the improvement of the energy density of lithium iron manganese, in terms of the installation cost of the battery, the cost of lithium iron manganese phosphate per watt-hour is slightly lower than that of lithium iron phosphate, and significantly lower than that of ternary batteries. However, lithium iron manganese phosphate material may also have some deficiencies, such as poor cycling performance at room temperature and high temperature, large irreversible capacity loss and significant voltage drop after storage at room temperature and high temperature. These deficiencies have a great impact on the delivery of battery factories and also have a great impact on the use of the end-customers.

The main reasons for the capacity fading of lithium iron manganese phosphate batteries are as follows: 1. When lithium iron manganese phosphate is deeply discharged or charged and discharged with high power, the manganese in the material is reduced to trivalent, and the formation of trivalent manganese in the state of delithiation seriously distorts the metal-oxygen octahedron, and this distortion may change the crystal lattice parameter and destroy the structure of the solid solution, which affects the service life of the positive electrode; 2. The Mn²⁺ may dissolve to the electrolyte, which leads to an irreversible loss of capacity; 3. The Mn²⁺ may be reduced and deposited in the negative electrode, which destroys the SEI film of the negative electrode, and results in the capacity fading. In addition, it has been shown that the direct capacity loss caused by manganese dissolution at room temperature only accounts for a small portion of the capacity loss, while the capacity loss caused by manganese dissolution at high temperatures is as high as 30% or more. Therefore, it is crucial to reduce the dissolution of manganese in lithium iron manganese phosphate materials to enhance the service life thereof.

Disclosed in the prior art is a lithium iron manganese phosphate battery and an electrolyte thereof. The high-temperature performance and cycling performance of the battery is improved by adding three types of additives to the electrolyte, i.e., fluoroether, 2-methylmaleic anhydride, and sulphate compounds. However, manganese-ion dissolution is not suppressed, so the improvement of high-temperature cycling and storage life is limited.

Disclosed in the prior art is a lithium iron phosphate power battery, and the solvent of the electrolyte is a composite of vinyl carbonate, ethyl methyl carbonate, dimethyl carbonate, ethyl acetate, and propylene carbonate, which improves the low-temperature performance of the lithium iron phosphate power battery. It only improves the components of the electrolyte solvent and plays no suppressive role in the dissolution of manganese from the cathode material of the lithium iron phosphate battery. Therefore, it is not applicable to high-temperature cycling.

Therefore, it is an important research direction in the art to develop an electrolyte and a lithium-ion battery that improves the high-temperature storage performance and high-temperature cycling performance of the electrolyte.

### SUMMARY

In view of the deficiencies existing in the prior art, the objective of the present application is to provide an electrolyte and lithium-ion battery improving the high-temperature storage performance and the high-temperature cycling performance of the electrolyte.

To achieve the objective, the following technical solutions are adopted in the present application.

As a first aspect, provided in the present application is an electrolyte, the electrolyte including a fluorosultones compound as shown in Formula 1, and

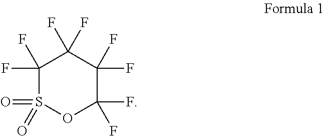 [SMILES: O=S1(=O)OC(F)(F)C(F)(F)C(F)(F)C1(F)F]

The fluorosultones compound as shown in Formula 1 in the present application is used as an additive in lithium iron manganese phosphate batteries to participate in the film formation of the positive electrode, which reduces the oxidation of the electrolyte on the surface of the cathode material, and suppresses the dissolution of manganese. Also, the structure of the fluorocarbon chain in the fluorosultones compound as shown in Formula 1 may improve the wettability of the electrolyte to a certain degree, and reduce the internal resistance of the battery.

The compound as shown in Formula 1 in the present application also forms a sulfur-containing SEI film (lithium alkylsulfonate, etc.) on the surface of the negative electrode preferentially to the solvent, and sulfur poisons many catalysts, so that the presence of sulfur in the SEI film effectively reduces the activity of the graphite electrode in reacting with the electrolyte, thereby suppressing side reactions such as the decomposition of solvent molecules.

In one implementation, a mass fraction of the fluorosultones compound in the electrolyte is 0.1˜1.5%, in which the mass fraction thereof may be, but is not limited to, such as 0.1%, 0.2%, 0.3%, 0.4%, 0.5%, 0.6%, 0.7%, 0.8%, 0.9%, 1.0%, 1.1%, 1.2%, 1.3%, 1.4% and 1.5%. Other values not listed in the range are also applicable, which is preferably 0.5˜1.0%.

In one implementation, the electrolyte also includes an additive.

In one implementation, the additive includes vinylidene carbonate and lithium bis(oxalate) borate.

The lithium bis(oxalate) borate in the additives in the present application may synergize with the fluorosultones compound shown in Formula 1 to form a dense and uniform protective film on the surface of lithium iron manganese phosphate, which effectively suppresses manganese dissolution. Also, the lithium bis(oxalate) borate complexes manganese-ions in the electrolyte, which avoids manganese-ion reduction on the surface of the negative electrode and destroys the negative electrode SEI film resulting in the obstruction of lithium-ion embedded channels.

In one implementation, a mass fraction of the vinylidene carbonate in the electrolyte is 0.1˜3.0%, in which the mass fraction thereof may be, but is not limited to, such as 0.1%, 0.5%, 1.0%, 1.5%, 2.0%, 2.5% and 3.0%. Other values not listed in the range are also applicable, which is preferably 1.0˜2.0%.

In one implementation, a mass fraction of the lithium bis(oxalate) borate in the electrolyte is 0.1˜3.0%, in which the mass fraction thereof may be, but is not limited to, such as 0.5%, 1.0%, 1.5%, 2.0%, 2.5% and 3.0%. Other values not listed in the range are also applicable, which is preferably 0.1˜0.5%.

In one implementation, the electrolyte also includes a lithium salt.

In one implementation, the lithium salt includes any one or a combination of at least two of LiPF₆, LiClO₄, LiBF₄, LiPO₂F₂, LiODFB, LiTFSI and LiFSI, in which the typical but non-limiting examples of the combinations are such as a combination of LiPF₆ and LiClO₄, a combination of LiPO₂F₂ and LiODFB, a combination of LiODFB and LiTFSI, and a combination of LiTFSI and LiFSI.

In one implementation, a mass fraction of the lithium salt in the electrolyte is 8˜12%, in which the mass fraction thereof may be, but is not limited to, such as 8%, 9%, 10%, 11% and 12%. Other values not listed in the range are also applicable.

In one implementation, the electrolyte also includes an organic solvent.

In one implementation, the organic solvent including at least two of ethylene carbonate, propylene carbonate, dimethyl carbonate, diethyl carbonate, ethyl methyl carbonate, propylene sulfite, ethyl acetate, diethyl sulfite, and 1,3-propanesultone.

In one implementation, the organic solvent includes at least two of ethylene carbonate, propylene carbonate, dimethyl carbonate, diethyl carbonate and ethyl methyl carbonate.

In one implementation, a mass fraction of the ethylene carbonate in the electrolyte is 30˜40%, in which the mass fraction may be, but is not limited to, 30%, 32%, 34%, 36%, 38% and 40%. Other values not listed in the range are also applicable.

In one implementation, a mass fraction of the ethyl methyl carbonate in the electrolyte is 30˜40%, in which the mass fraction may be, but is not limited to, 30%, 32%, 34%, 36%, 38% and 40%. Other values not listed in the range are also applicable.

In one implementation, a mass fraction of the diethyl carbonate in the electrolyte is 30˜40%, in which the mass fraction may be, but is not limited to, 30%, 32%, 34%, 36%, 38% and 40%. Other values not listed in the range are also applicable.

As a second aspect, provided in the present application is a lithium-ion battery, the lithium-ion battery including a positive electrode sheet, a negative electrode sheet, a separator and the electrolyte as described in the first objective.

In one implementation, the positive electrode sheet includes a positive current collector and a cathode material provided on the positive current collector.

In one implementation, the cathode material includes positive electrode active substance, the positive electrode active substance including lithium iron manganese phosphate.

In one implementation, the negative electrode sheet includes a negative current collector and an anode material provided on the negative current collector.

In one implementation, the anode material includes negative electrode active substance, the negative electrode active substance including graphite.

Compared to the prior art, the present application has beneficial effects as follows.

The electrolyte prepared in the present application is applied to lithium iron manganese phosphate batteries, which effectively suppresses the dissolution of manganese in lithium iron manganese phosphate materials, and significantly improves the high-temperature storage performance and high-temperature cycling performance of the batteries. Stored at 60° C. for 30 days, the capacity maintaining rate of the battery may reach 85%; the capacity restoration rate may reach more than 91%; the thickness growth rate may be down to 3.4%; and the capacity maintaining rate may be up to 88% after 1,000 cycles at 45° C. under 1 C /1 C cycling.

### DETAILED DESCRIPTION OF THE PREFERRED EXAMPLES

The technical solutions of the present application are further described hereinafter by specific examples.

### Example 1

Provided in the present example is an electrolyte, the electrolyte including a fluorosultones compound as shown in Formula 1, and

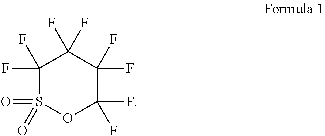 [SMILES: O=S1(=O)OC(F)(F)C(F)(F)C(F)(F)C1(F)F]

The present example also includes an additive, an organic solvent and a lithium salt,

wherein in terms of a mass fraction of the electrolyte being 100%, the additives are that of 1.5% vinylidene carbonate (VC) and that of 0.5% lithium bis(oxalate) borate (LiBOB), and the lithium salt is that of 10% lithium hexafluorophosphate.

The remaining are organic solvents, which are ethylene carbonate (EC), ethyl methyl carbonate (EMC) and diethyl carbonate (DEC) in the mass ratio of 3:4:3.

Provided in the present example is also a preparation method of a lithium-ion battery, the preparation method including:

Preparation of the positive electrode sheet:

The mass ratio of LiFePO₄: Super-P Conductive Carbon Black (SP): Carbon nanotube (CNT): Polyvinylidene fluoride (PVDF)=95.0 2.0:0.5:2.5. Positive electrode gels are made by using PVDF and the solid content of the gels is 1.327%. In the first step, LiFePO₄, SP, and N-Methylpyrrolidone (NMP) are added, with a rotation of 25±1 r/min, a dispersion of 500±50 r/min, stirring for 10 min, then a rotation of 25±1 r/min, a dispersion of 1000±50 r/min, stirring at 45 ° C. for 90 min. In the second step, the conductive CNT slurry is added, with a rotation of 25±1 r/min, a dispersion of 1000±50 r/min, a vacuum level of 0.080 KPa, and stirring at 45° C. for 60 min. In the third step, the positive electrode gel solution is added, with a rotation of 25±1 r/min, a dispersion of 2500±50 r/min, a vacuum level of 0.080 KPa, and stirring for 90 min at 45° C. The fourth step is the viscosity adjustment step, adding NMP to adjust the viscosity of the slurry. The fifth step is to stir slowly, with a rotation of 15±1 r/min, a dispersion of 500±50 r/min, a vacuum level of 0.080 KPa, and stirring for 0.5 h to cool down. Ensuring that the viscosity of the positive output material is 20000±5000 mPa˜s, and the fineness is ≤15 μm. Promptly scrape deposited material from the wall of the stirring cylinder and the stirring rod at each step. After sieving, coating, cold pressing and slitting, the positive electrode sheet is prepared.

Preparation of negative electrode sheet: Graphite:

The mass ratio of Super-P Conductive Carbon Black (SP): carboxymethylcellulose (CMC): styrene-butadiene rubber (SBR)=95.5:1.5:1.2:1.8. Negative electrode gels are made by using CMC and the solid content of the gels is 8%. In the first step, graphite and SP are added to be mixed, with a rotation of 20±1 r/min, a dispersion of 1000±50 r/min, and stirring for 1 h. In the second step, 50% negative electrode slurry is added, with a rotation of 20±1 r/min, a dispersion of 1000±50 r/min, and stirring for 1.5 h. In the third step, the other 50% of the negative electrode slurry is added, with a rotation of 25±1 r/min, a dispersion of 2000±50 r/min, a vacuum level of 0.085 KPa, and stirring for 1 h. The fourth step is the viscosity adjustment step, adding deionized water to adjust the viscosity of the slurry. In the fifth step, the aqueous dispersant SBR is added, with a rotation of 25±1 r/min, a dispersion of 800±50 r/min, a vacuum level of 0.085 KPa, and stirring for lh to finish. Ensuring that the viscosity of the negative output material is 4000±1500 mPa·s, and the fineness is ≤20 μm. Promptly scrape deposited material from the wall of the stirring cylinder and the stirring rod at each step. After sieving, coating, cold pressing and slitting, the negative electrode sheet is prepared.

A lithium-ion battery is assembled by assembling the above-mentioned positive electrode sheet, negative electrode sheet and electrolyte.

Examples 2-8 and contrast examples 1-3 make changes in the composition and content of the electrolyte in Example 1, as shown in Table 1.

TABLE 1

| Electrolyte | | | Lithium |
|---|---|---|---|
| No. | Organic Solvent | Additive | salt |
| Example 1 | EC:EMC:DEC = | VC 1.5% + LiBOB 0.5% + | 10% |
| | 3:4:3 | Formula 1 1.0% | |
| Example 2 | EC:EMC:DEC = | VC 1.5% + LiBOB 0.5% + | 10% |
| | 3:4:3 | Formula 1 0.5% | |
| Example 3 | EC:EMC:DEC = | VC 1.5% + LiBOB 0.5% + | 10% |
| | 3:4:3 | Formula 1 0.2% | |
| Example 4 | EC:EMC:DEC = | VC 1.5% + LiBOB 0.5% + | 10% |
| | 3:4:3 | Formula 1 1.5% | |
| Example 5 | EC:EMC:DEC = | VC 1.5% + Formula 1 1.0% | 10% |
| | 3:4:3 | | |
| Example 6 | EC:EMC:DEC = | VC 1.5% + LiBOB 0.08% + | 10% |
| | 3:4:3 | Formula 1 1.0% | |
| Example 7 | EC:EMC:DEC = | LiBOB 0.5% + Formula 1 | 10% |
| | 3:4:3 | 1.0% | |
| Example 8 | EC:EMC:DEC = | VC 0.5% + LiBOB 0.5% + | 10% |
| | 3:4:3 | Formula 1 1.0% | |
| Contrast | EC:EMC:DEC = | VC 1.5% + LiBOB 0.5% | 10% |
| Example 1 | 3:4:3 | | |
| Contrast | EC:EMC:DEC = | VC 2.5% + LiBOB 0.5% | 10% |
| Example 2 | 3:4:3 | | |
| Contrast | EC:EMC:DEC = | VC 1.5% | 10% |
| Example 3 | 3:4:3 | | |

The lithium-ion batteries prepared in Examples 1-8 and Contrast Examples 1-3 mentioned above are tested for high-temperature storage performance and cycling performance, and the test results are shown in Table 2.

The high-temperature storage performance test was performed as:
1) Shelving for 10 min at 25±2° C.
2) The battery is charged to 4.2V at 0.5 C constant current and constant voltage and discharged to 2.5V at 0.5 C constant current for 5 cycles.
3) The battery is charged to 4.2V at 0.5 C constant current and constant voltage.
4) Recording the voltage, internal resistance, and thickness of the battery cell before storage.
5) The battery is stored at 60±2° C. for 30 days.
6) End of storage, and recording the voltage, internal resistance, and thickness of the battery cell after storage.
7) The battery is discharged to 2.5V at 25±2° C. at 0.5 C constant current.
8) The discharge capacity of the battery cell in step 7) is recorded, and the capacity maintaining rate may be indicated as the ratio of the discharge capacity in step 7) to the average discharge capacity of the last 3 cycles of step 2).
9) The battery is standard cycled for 5 cycles at 25±2° C.; if the battery is not stored afterward, the battery should be discharged completely.
10) The discharge capacity of the battery cell in step 9) is recorded, and the capacity restoration capability may be indicated as the ratio of the discharge capacity of the first cycle of step 9) to the average discharge capacity of the last 5 cycles of step 2).

The cycling performance test is performed by charging the battery to 4.2V at 1 C constant current and constant voltage, discharging it to 2.5V at 1 C constant current and cycling the battery for 5 cycles.

TABLE 2

| | | | | Capacity |
|---|---|---|---|---|
| | Storage at 60° C. for 30 days | | | Maintaining |
| | | Capacity | Thickness | Rate (%) after |
| | Capacity | Restoration | Increasing | 1000 cycles at |
| | Maintaining | Rate | Rate | 45° C. under |
| | Rate (%) | (%) | (%) | 1 C/1 C cycling |
| Example 1 | 85.66 | 91.09 | 3.39 | 88.32 |
| Example 2 | 85.59 | 91.12 | 3.37 | 88.35 |
| Example 3 | 83.20 | 88.97 | 9.75 | 84.60 |
| Example 4 | 84.28 | 89.54 | 9.36 | 85.00 |
| Example 5 | 80.11 | 85.36 | 8.19 | 80.64 |
| Example 6 | 83.07 | 88.65 | 7.34 | 85.29 |
| Example 7 | 81.31 | 86.90 | 8.02 | 82.41 |
| Example 8 | 82.68 | 88.29 | 6.88 | 85.45 |
| Contrast | 78.22 | 85.06 | 12.42 | 78.67 |
| Example 1 | | | | |
| Contrast | 79.93 | 85.04 | 10.76 | 80.99 |
| Example 2 | | | | |
| Contrast | 76.29 | 84.33 | 14.05 | 76.63 |
| Example 3 | | | | |

It may be concluded from the above table that both the high-temperature storage performance and the cycling performance of the batteries are degraded when the amount of the compound shown in Formula 1 in Examples 3-4 is added too low or too high. Therefore, the high-temperature performance of the battery in the present application is optimal when the content of the compound is between 0.5 and 1%. By increasing the addition amount of the compound shown in Formula 1 in Example 4, the electrochemical performance of the battery is not improved relative to Example 1, but rather the cost is increased. The high-temperature performance of the battery is degraded by the absence of adding lithium bis(oxalate) borate in Example 5, and by adding too low amount of lithium bis(oxalate) borate in Example 6. The high-temperature performance of the battery is degraded in Examples 7-8 by the absence of adding vinylidene carbonate and by adding too low amount of vinylidene carbonate.

The high-temperature performance of the battery is significantly degraded without adding the compound as shown in Formula 1 in Contrast Example 1. The high-temperature performance of the battery is slightly, but not significantly, improved by increasing the content of vinylidene carbonate in Contrast Example 2 on the basis of Contrast Example 1, while the electrochemical performance of the battery is further degraded by the absence of adding lithium bis(oxalate) borate in Contrast Example 3 on the basis of Contrast Example 1. It is shown that the performance of the electrolyte is further improved by providing a synergistic effect of lithium bis(oxalate) borate, and vinylidene carbonate in the presence of the compound shown in Formula 1.

1. An electrolyte, the electrolyte comprising a fluorosultones compound as shown in Formula 1, and

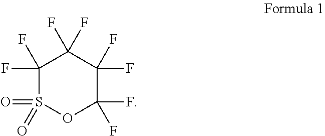 [SMILES: O=S1(=O)OC(F)(F)C(F)(F)C(F)(F)C1(F)F]

2. The electrolyte according to claim 1, wherein a mass fraction of the fluorosultones compound in the electrolyte is 0.1˜1.5%.

3. The electrolyte according to claim 2, wherein a mass fraction of the fluorosultones compound in the electrolyte is 0.5˜1.0%.

4. The electrolyte according to claim 1, wherein the electrolyte also comprises an additive, the additive comprising vinylidene carbonate and lithium bis(oxalate) borate.

5. The electrolyte according to claim 4, wherein a mass fraction of the vinylidene carbonate in the electrolyte is 0.1˜3.0%, and a mass fraction of the lithium bis(oxalate) borate in the electrolyte is 0.1˜3.0%.

6. The electrolyte according to claim 5, wherein a mass fraction of the vinylidene carbonate in the electrolyte is 1.0˜2.0%, and a mass fraction of the lithium bis(oxalate) borate in the electrolyte is 0.1˜0.5%.

7. The electrolyte according to claim 1, wherein the electrolyte also comprises a lithium salt, the lithium salt comprising any one or a combination of at least two of LiPF₆, LiClO₄, LiPO₂F₂, LiODFB, LiTFSI and LiFSI.

8. The electrolyte according to claim 7, wherein a mass fraction of the lithium salt in the electrolyte is 8˜12%.

9. The electrolyte according to claim 1, wherein the electrolyte also comprises an organic solvent, the organic solvent comprising at least two of ethylene carbonate, propylene carbonate, dimethyl carbonate, diethyl carbonate, ethyl methyl carbonate, propylene sulfite, ethyl acetate, diethyl sulfite, and 1,3-propanesultone. The electrolyte according to claim 9, wherein the organic solvent comprises in the electrolyte at least two of ethylene carbonate, propylene carbonate, dimethyl carbonate, diethyl carbonate and ethyl methyl carbonate.

11. The electrolyte according to claim 10, wherein a mass fraction of the ethylene carbonate in the electrolyte is 30˜40%.

12. The electrolyte according to claim 10, wherein a mass fraction of the ethyl methyl carbonate in the electrolyte is 30˜40%.

13. The electrolyte according to claim 10, wherein a mass fraction of the diethyl carbonate in the electrolyte is 30˜40%.

14. A lithium-ion battery, wherein the lithium-ion battery comprises a positive electrode sheet, a negative electrode sheet, a separator and an electrolyte comprising a fluorosultones compound as shown in Formula 1, and

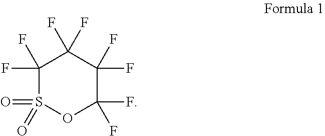 [SMILES: O=S1(=O)OC(F)(F)C(F)(F)C(F)(F)C1(F)F]

15. The lithium-ion battery according to claim 14, wherein a mass fraction of the fluorosultones compound in the electrolyte is 0.1˜1.5%.

16. The lithium-ion battery according to claim 15, wherein a mass fraction of the fluorosultones compound in the electrolyte is 0.5˜1.0%.

17. The lithium-ion battery according to claim 14, wherein the positive electrode sheet comprises a positive current collector and a cathode material provided on the positive current collector.

18. The lithium-ion battery according to claim 17, wherein the cathode material comprises positive electrode active substance, the positive electrode active substance comprising lithium iron manganese phosphate.

19. The lithium-ion battery according to claim 14, wherein the negative electrode sheet comprises a negative current collector and an anode material provided on the negative current collector.

20. The lithium-ion battery according to claim 19, wherein the anode material comprises negative electrode active substance, the negative electrode active substance comprising graphite.
